(19) United States
(12) Patent Application Publication
(10) Pub. No.: US 2006/0289066 A1
(43) Pub. Date: Dec. 28, 2006

(54) Pre-assembled hot water heater mixing valve for hot water heaters

(76) Inventor: Claude Lesage, Pointe Claire (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/159,188

(22) Filed: Jun. 23, 2005

(51) Int. Cl. F16K 27/00

(52) U.S. Cl. 137/375

(57) ABSTRACT

A pre-assembled hot water heating mixing valve for securement to a hot water outlet pipe of a hot water heater. The mixing valve has a hot water inlet port coupling. A cold water coupling is secured to a cold water inlet port of the valve and adapted to be secured to a domestic water supply. A domestic tempered water coupling is secured to the tempered water outlet port of the valve and adapted to be secured to a domestic hot water distribution pipe. The cold water and domestic hot water couplings are pipe couplings having an inner lining which is non-conductive to die-electric currents inside the couplings caused by different adjoining metals, whereby to substantially prevent foreign matter due to deterioration of these metals at their joints from entering the valve to cause a malfunction thereof affecting the hot water temperature and the risk of causing scalding to the skin of the users.

### TECHNICAL FIELD

The present invention relates to a pre-assembled hot water heater mixing valve for connection to the hot water outlet pipe of a hot water heater.

### BACKGROUND ART

Mixing valves are known whereby to control the temperature of the hot water being supplied to domestic hot water distribution conduits associated with a hot water heater. This tempered water temperature is usually about 120° F., which is a safe water temperature. Such mixing valves are provided with three ports each having a threaded connector whereby to couple exterior piping thereto by the use of a union connector or other suitable type connectors. A washer is introduced between the union connector and the threaded connector as is well known in the art. These union connectors are usually metal fittings and the size of these fittings can vary depending on building codes of different cities. Therefore, during installation a plumber will adapt the necessary connectors or reducers to suit each installation. This adaptation usually requires welding and seeing that these connectors are metal and therefore heat conductive, during welding the seals will be subjected to high temperature and the integrity thereof can be affected. Also, because very hot water and cold water flow through these valves, the seals are subjected to fatigue due to changes in temperature and eventually a leak will occur and further causing oxidation in the connected joints. The connectors accordingly develop rust and rust particles can be released into the water flowing through the valve and lodge themselves in sensitive parts of the valve, thereby causing malfunctions. For example, most of these valves utilize bi-metal sensors and affecting the operation of the bi-metal by a small increment could result in a substantial change in temperature at the outlet of a mixing valve causing the utilizers to scald their skin at the touch of this excessively hot water.

A further disadvantage of these valves is that their installation requires the use of experienced personnel, as well as for repair to replace defective parts such as O-ring seals, which are not expensive parts but expensive labour is required to replace. A malfunction in the valve requires for the hot water heater to be shut off depriving the users of this necessity during repair. Scalding of the users could also result in legal action being taken against the hot water tank supplier or the installation company.

Still further, these valves as well as multi-port hot water heaters result in energy loss about 20 watts per hour per hot water outlets.

### SUMMARY OF INVENTION

It is a feature of the present invention to provide a pre-assembled hot water heater mixing valve which substantially overcomes the above-mentioned disadvantages of the prior art.

Another feature of the present invention is to provide a pre-assembled hot water heater mixing valve which substantially reduces assembly time on a hot water heater and which greatly reduces the risk of foreign particles caused by rusting to infiltrate the valve.

Another feature of the present invention is to provide a pre-assembled hot water heater mixing valve which uses cold and domestic hot water couplings which have a non-conductive lining therein whereby to shield die-electric currents caused by interconnected parts of different metals from the water flow preventing the release of rust particles into the water flowing through the valve and its couplings.

Another feature is to provide a factory assembled mixing valve which permits the construction of a standard adaptable insulation jacket securable thereto to achieve further energy efficiency.

According to the above features, from a broad aspect, the present invention provides a pre-assembled hot water heater mixing valve for securement to a hot water outlet pipe of a hot water heater. The mixing valve has a hot water inlet port coupling adapted to be secured to the hot water outlet pipe. A cold water coupling is secured to a cold water inlet port of the valve and is adapted to be secured to a domestic water supply. A domestic tempered water coupling is secured to a tempered water outlet port of the valve and adapted to be secured to a domestic hot water distribution pipe. The cold water and domestic hot water couplings are pipe couplings having an inner lining which is non-conductive to shield die-electric currents inside the couplings, caused by different adjoining metals, whereby to substantially prevent foreign matter due to deterioration of these metals at their joints from entering the valve to cause a malfunction thereof affecting the hot water temperature and the risk of causing scalding to the skin of the users.

### BRIEF DESCRIPTION OF DRAWINGS

A preferred embodiment of the present invention will now be described with reference to the accompanying drawings in which:

FIG. 1 is a perspective view of a hot water heater mixing valve of the prior art assembled about the hot water outlet of a hot water heater;

FIG. 2 is an exploded perspective view showing the construction of the prior art mixing valve illustrated in FIG. 1;

FIG. 3 is a perspective view of the pre-assembled hot water heater mixing valve of the present invention;

FIG. 4 is an exploded perspective view of the pre-assembled hot water heater mixing valve of the present invention;

FIG. 5 is a simplified schematic view showing the pre-assembled hot water heater mixing valve connected to the hot water outlet pipe of a hot water heater; and

FIG. 6 is an exploded view showing an insulating jacket for securement about the pre-assembled mixing valve after installation on a hot water heater.

### DESCRIPTION OF PREFERRED EMBODIMENTS

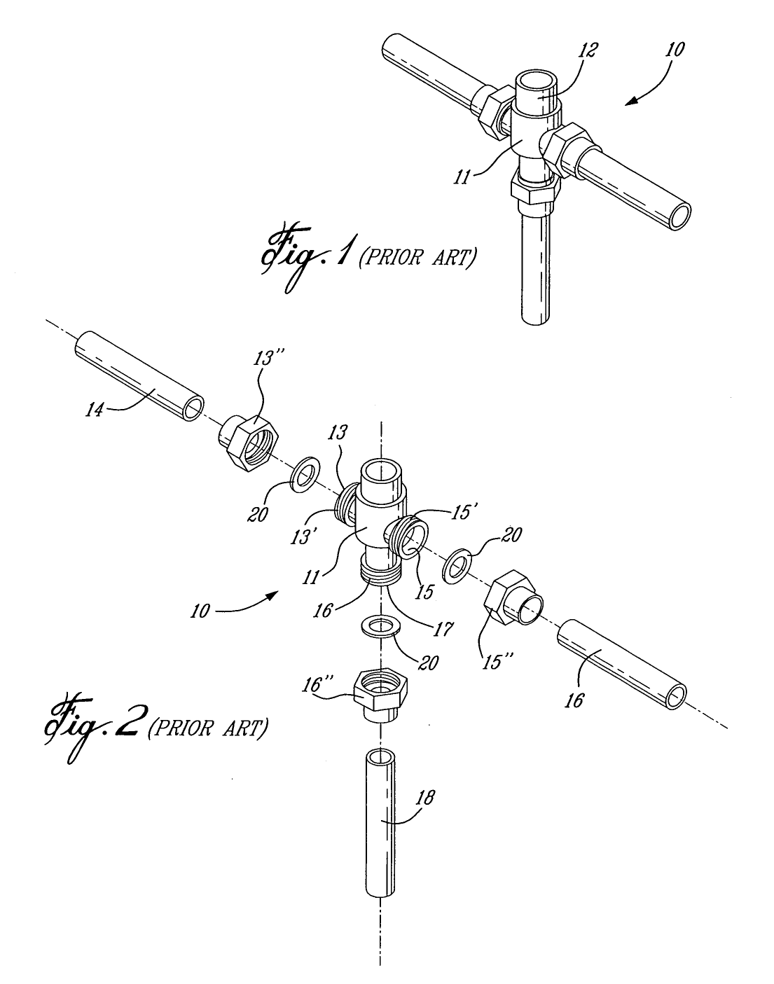

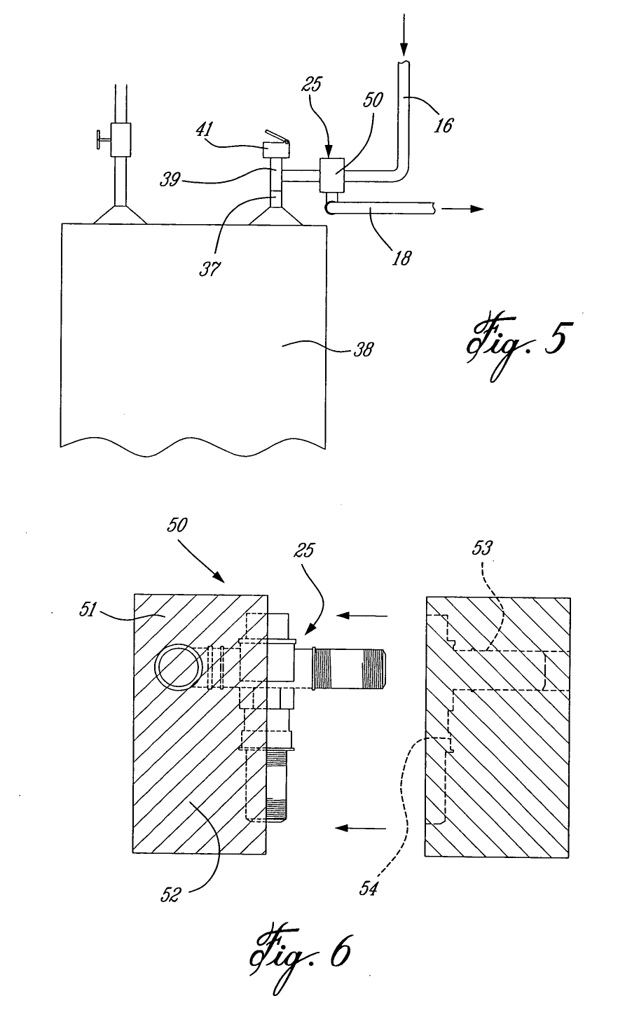

Referring now to the drawings and more particularly to FIG. 1, there is shown generally at 10 a mixing valve of the prior art having a body 11, the top of which is provided with a removable cap 12 for access to a temperature regulating device, not shown herein, but obvious to a person skilled in the art, whereby to set a desired hot water outlet temperature for the valve. As more clearly illustrated in FIG. 2, the body 11 has three ports, namely a first port 13 for securement to hot water piping 14 at the hot water outlet of a hot water heater (see FIG. 5), a second port 15 for securement to the domestic cold water supply pipe 16, and a third port 17 for securement to the domestic hot water distribution piping 18. All of this piping, 14, 16 and 18, is coupled by providing threaded connectors 13′, 15′ and 17′ about their associated ports. These threaded connectors receive respective union connectors 13″, 15″ and 16″ which are welded to the piping. Washers 20 are fitted in the union to provide a seal. These washers are usually made from rubber, or other suitable materials.

Because these mixing valves are assembled by plumbers on site, each plumber has his own technique and the installation is subject to National State or Municipal building codes. Also, the pipings in different homes vary from one another, i.e., it could be copper piping, galvanized steel piping and even plastic piping. Often, welding is associated with the securement of the unions to the piping and often this welding is done while the union is assembled on the valve body. This results in heat being conducted in the valve body and this can affect the sensitivity of the sensitive elements within the mixing valve. It also affects the integrity of the washers. Further, because these mixing valves operate at hot and cold temperatures, these temperature differentials cause deformation of the washers and also of the connectors resulting in leakage and infiltration of foreign matter, such as rust particles, into the valve.

Another problem with these prior art valve assemblies is that when different metals are connected together, the similar metals induce a die-electric current due simply to its nature, and this takes place even with similar materials of different temper, i.e. hardness. These die-electric currents also result in deterioration of the couplings at their joints causing rust and rust particles being released within the water. These small particles of rust can greatly affect the proper operation of the bi-metal sensors within the mixing valve thereby affecting its proper operation and often resulting in loss of control of the hot water temperature at the outlet of the valve leading to the domestic hot water distribution piping. This excessively hot water can cause scalding of the skin thereby inflicting serious injuries to the users.

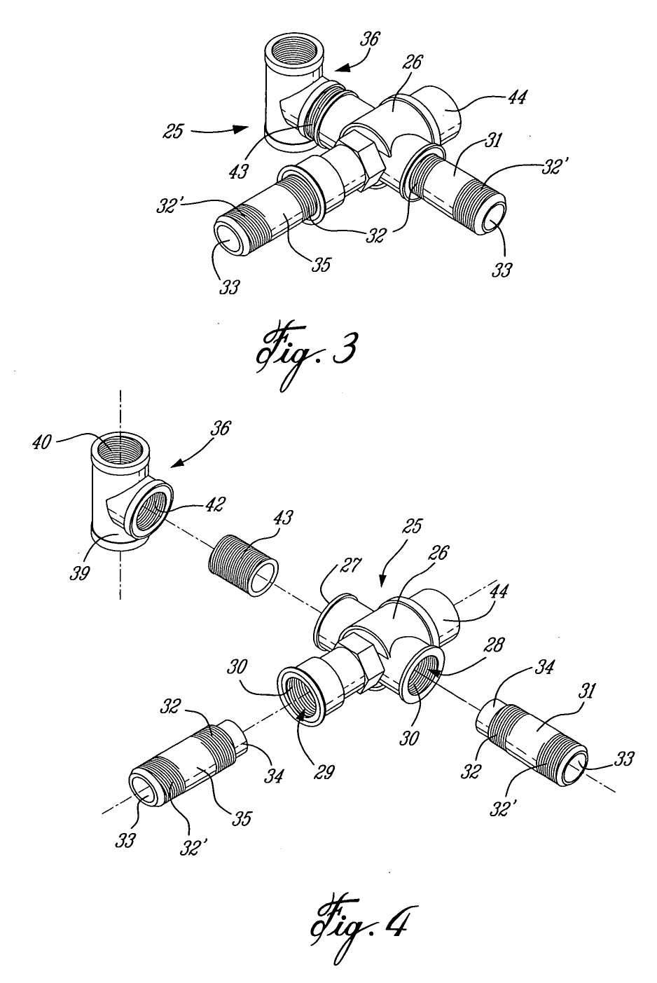

With reference now to FIGS. 3 to 5, there will be described the pre-assembled hot water heater mixing valve 25 of the present invention. More specifically, with reference to FIG. 4, there is shown the mixing valve 25 and it is comprised of a valve body 26 usually constructed from brass. It has a hot water inlet port 27, a cold water inlet port 28 and a tempered water outlet port 29. These ports are couplings for receiving threaded piping in a pre-assembly before installation on a hot water tank.

As hereinshown, a cold water pipe coupling 31 has outer threads 32 at opposed ends thereof and is provided with an inner, non-conductive lining 33 formed of suitable plastics material. This plastic material is injected inside the pipe coupling 31 and may have a slight outer extension at opposed ends of the pipe as illustrated by reference numeral 34. The pipe coupling 31 is factory assembled to the body 26. A like domestic hot water pipe coupling 35 is also pre-assembled in the tempered water outlet port 29 and it is also provided with a non-conductive lining 33. Accordingly, the lining shields the couplings from conducting die-electric currents inside the pipes within the water flowing therethrough. These die-electric currents resulting primarily at the connection joint with the outer ones 32′ of the threads formed on these pipe couplings 31 and 35. The non-conductive lining as hereinshown is a suitable polypropylene injected plastic lining.

The hot water pipe coupling 36 which secures to the hot water outlet pipe 37, as shown in FIG. 5 of a hot water heater 38 is hereinshown as comprising a T-shaped brass pipe coupling 39 provided with a through bore 40 having an inner thread at opposed ends for securement at one end to the hot water outlet pipe 37 and at an opposed end to a safety valve 41 (see FIG. 5), as is well known in the art. A transverse threaded bore 42 communicates with the through bore 40 and receives a threaded brass pipe 43 for securement to the inner thread 30 of the hot water inlet port 27 of the valve. The temperature regulating device can be positioned in the mixing valve 25 in a last step whereby not to be accidentally damaged during assembly.

Like the prior art valve, it is also provided with a removable cap 44 for access to a temperature regulating device. It is also pointed out that the cold water and hot water pipe connectors 31 and 35 are of a minimum predetermined length of two and one half (2%) inches, end-to-end, whereby to absorb heat during welding to domestic piping from union connectors, such as those shown in FIGS. 1 and 2 or other type connectors, depending on the building codes. Accordingly, when the mixing valve is being installed by a plumber, or other such qualified person, the mixing valve and its pipe connectors are all pre-assembled and there are no O-ring seals within the assembly. A sealing tape or compound may be utilized between the inner threads 30 of the ports of the valve and the pipe connectors. Also, the pipe connectors requiring attachments where welding is necessary are all provided with a non-conducting inner lining maintaining die-electric current exteriorly of the water supply, thereby substantially eliminating the formation of rust and calcium deposits, which release particles, from forming inside the pipes. Such particles, if released in the water could affect the sensitive component parts of the valve. The mixing valve also uses standard ¾ inch NPT (National Pipe Thread) threads for securement to standard union connectors in accordance with the North American industry trade standards. Such a mixing valve provides a trouble-free installation, results in time savings, prevents malfunctioning, requires substantially no maintenance after installation, does not deteriorate and accordingly prevents scalding and problems associated therewith to the manufacturer, installer and insurance companies.

Another important advantage of the pre-assembled mixing valve of the present invention is the integration of the safety valve 41 therewith. Usually there are two outlet couplings to a hot water tank, one for the safety valve which protects the tank against excess pressure and temperature and the other one for the hot water outlet. By integrating both the safety valve with the mixing valve, only one outlet port is necessary. Thus, a second outlet port is eliminated by this integration and this results in an extended life of the hot water tank by about 6 months. The reason for this is that when a hole is bored within the inner steel casing of the hot water tank, there is created a sharp bear edge on the inside wall of the tank around the hole. When the inner surface of the tank is coated with a glass lining, the glass will not adhere to this sharp edge. To compensate for exposed steel in the inner casing, a magnesium alloy rod is disposed within the hot water tank and it releases magnesium ions which are attracted to bare metal whereby to provide cathode protection of the exposed steel to prevent rusting and deterioration. Therefore, by eliminating one of the holes, the magnesium alloy rod will last much longer as it will use less magnesium ions to protect the tank.

With reference now to FIG. 6, it is pointed out that because the mixing valve 25 is factory assembled, its shape becomes standard. Accordingly, it is possible to fabricate an insulating jacket 50 formed of jacket portions 51, 52 and 53 which fit about the mixing valve 25 to completely insulate the valve resulting in a gain of about 20 watts per hour. The jacket 50 may be formed of polystyrene foam with precise cavity 54 to receive sections of the valve 25 as the valve and its coupling are always the same. The valve 25 is an energy saver as it permits insulation thereof by a standard jacket. The valve assembly also secures to a single outlet of the tank thereby eliminating multi-ports and again saving in energy loss.

It is within the ambit of the present invention to cover any obvious modifications of the preferred embodiment described herein, provided such modifications fall within the scope of the appended claims.

I claim:

1. A pre-assembled hot water heater mixing valve for securement to a hot water outlet pipe of a hot water heater, said mixing valve having a hot water inlet port coupling adapted to be secured to said hot water outlet pipe, a cold water coupling secured to a cold water inlet port of said valve and adapted to be secured to a domestic water supply, a domestic tempered water coupling secured to a tempered water outlet port of said valve and adapted to be secured to a domestic hot water distribution pipe, said cold water and domestic hot water couplings being pipe couplings having an inner lining which is non-conductive to shield die-electric currents inside said couplings, caused by different adjoining metals whereby to substantially prevent foreign matter due to deterioration of these metals at their joints from entering said valve to cause a malfunction thereof affecting the hot water temperature and the risk of causing scalding to the skin of the users.

2. A hot water heater mixing valve as claimed in claim 1 wherein said inner lining is a suitable plastics material inner lining.

3. A hot water heater mixing valve as claimed in claim 2 wherein said inner lining is a polypropylene injected plastic lining spanning opposed ends of said pipe couplings.

4. A hot water heater mixing valve as claimed in claim 3 wherein said pipe couplings are metal pipe couplings having a threaded outer end about an outer surface portion thereof for receiving a plumbing union adaptor to connect to household piping by welding.

5. A hot water heater mixing valve as claimed in claim 1 wherein said hot water inlet port coupling comprises a brass T-coupling, said T-coupling having a through bore threaded at opposed ends for securement at one end to said hot water outlet pipe and at an opposed end to a safety valve, and a transverse threaded bore for receiving a threaded brass pipe for securement to a threaded hot water inlet port of said mixing valve.

6. A hot water heater mixing valve as claimed in claim 5 wherein said mixing valve has a removable cap at an extension portion thereof for access to a temperature regulating device to set a desired hot water outlet temperature.

7. A hot water heater mixing valve as claimed in claim 6 wherein said cold water and domestic hot water couplings are brass pipes of predetermined length to absorb heat during welding to domestic piping.

8. A hot water heater mixing valve as claimed in claim 1 wherein said hot water mixing valve couplings are threaded couplings secured directly to threaded bores of said mixing valve without the use of O-ring seals which deteriorate due to fatigue or contamination by foreign particles in water.

9. A hot water heater mixing valve as claimed in claim 1 wherein there is further provided a preformed insulation jacket comprised of jacket portions securable about said mixing valve to insulate said pre-assembled valve.

10. A hot water heater mixing valve as claimed in claim 1 wherein a safety valve is secured in said hot water inlet port coupling of said mixing valve coupled to said hot water outlet pipe of said hot water heater whereby both said safety valve and mixing valve are secured to a common outlet pipe secured to an inner tank of said hot water heater thereby prolonging the life of said hot water heater.
